(19) United States
(12) Patent Application Publication
(10) Pub. No.: US 2008/0257893 A1
(43) Pub. Date: Oct. 23, 2008

(54) BULK LIQUID TRANSPORT SYSTEM

(76) Inventors: Stephen D. Podd, Rouses Point, NY (US); Victor I. Podd, Boca Raton, FL (US)

Correspondence Address: TURNER PADGET GRAHAM & LANEY, P.A., P.O. BOX 1509, GREENVILLE, SC, 29602, US

(21) Appl. No.: 11/737,651

(22) Filed: Apr. 19, 2007

(51) Int. Cl. B65D 88/12; B29C 43/10

(52) U.S. Cl. 220/562; 264/571

(57) ABSTRACT

A transport tank system includes a molded thermoplastic tank defining an aperture therethrough and having a discharge end and an opposing end, the thermoplastic tank being rigidly configured for holding a consumable cargo received through the aperture and including a material resistant to passage of oxygen to preserve the consumable cargo. The tank is capable of standing alone for storing the consumable cargo, or the tank can be loaded into a standard dry box container to convert the dry box container into a bulk liquid transport container.

### BACKGROUND OF THE DISCLOSURE

A variety of procedures and systems are used to transport liquids in bulk quantities. For instance, vehicles designed for liquid transport are available in motor, sea and rail transport forms. A drawback to this type of liquid cargo transport is backhaul, which occurs in the industry because cargo is carried by the vehicle on the chance that the cargo will have to be carried in both directions of a trip. More specifically, backhaul occurs because a vehicle designed exclusively for liquid cargo cannot be used for other types of cargo. Therefore, backhaul reduces the productivity of the vehicle.

Attempts have been made to use general purpose vehicles for transport of liquid cargo. One known method is to secure a deformable liner to inner walls of a cargo vehicle. The bottom of the liner rests on the floor of the vehicle. As the vehicle is loaded, the liquid presses the liner against the floor and walls thus filling the vehicle. While useful for some types of cargo, this method is undesirable for food or other products that may be susceptible to contamination or spoiling. Additionally, since the cargo is unrestrained in the liner-general purpose vehicle, any movement of the vehicle may cause a surging weight shift that can destabilize the vehicle. Baffles have been used to reduce the surging problem in this type of container, but the baffles increase the cost of the liner. Baffles also increase transport surface area exposed to the cargo, which increases the possibility of contamination. Moreover, baffles ultimately have a relatively limited effect on surging due to the high mass of most liquid cargos.

Flexitank or pillow containers have been developed that are sealed to prevent exposure to ambient air. These flexitank containers typically have air pockets which allow surging when the vehicle is in motion. However, bulkheads are often required to hold the ends of the bags in place when vehicle doors are opened. Also, bulkheads are typically expensive and time consuming to install, and often, approval from government agencies such as the U.S. Food and Drug Administration is required to use flexitanks. Moreover, when transporting food stuffs or other consumable items, flexitanks often require inner liners, which add to their cost.

As shown in FIG. 7, when attempting to convert and utilize a conventional transport system 701 to carry a liquid cargo, a dry box shipping container 703 usually must be lined with plastic or cardboard 705 prior to the installation of the flexitank 707 in order to prevent punctures and leakage of the flexitank 707. If the flexitank 707 is punctured, or if a seal breaks, an entire cargo can be lost due to drainage.

As is evident from FIG. 7, the flexitank 707 when fully filled can place extreme stresses on the walls of the dry box shipping container 703, which can cause the walls and doors to blow out during transport. This is extremely prevalent during rail voyages where rail cars are shunted. Total losses of such dry box shipping containers are not uncommon with claims and damages ultimately being incurred by the shippers and costs passed on to consumers.

In addition to the foregoing problems, due to ensuing and expensive environmental cleanup issues, many steamship lines simply have banned the use of the flexitank or pillow containers.

Shipment of bulk liquids has also been attempted by loading the liquid into drums and securing the drums inside the transport vehicles. While this approach tends to reduce exposure to air, which may contaminate some cargo, this method has proven to be unsuitable for most food items since avoiding metal contact with food items is practically impossible and contamination is nevertheless possible.

Yet a further disadvantage of using drums for liquid cargo shipment is the high cost entailed. The drums themselves are expensive, and filling, loading and unloading each drum are expensive, labor consuming activities. Additionally, as the drums are loaded onto the vehicle, they must be restrained, or else movement of the vehicle may cause the drums to be damaged or overturned in transmit. Thus, the cost of using drums is increased further due to the need to provide pallets on which to secure the drums during transmit. More specifically, the cost of the pallets and fumigation become part of the cost of the cargo. Also, the space taken by the pallets during the trip reduces the amount of usable cargo space. Finally, the drums themselves must be disposed of or returned at the end of each transmit.

Another attempt to ship bulk liquid, viscous, or powder cargo has been to use containers approved by the International Organization for Standardization (ISO). However, these stainless steel ISO containers are very expensive and to be commercially viable, they require thousands of shipments and must be amortized over decades. Additionally, invariably repositioning and repairing ISO containers incur substantial costs. All told, the high costs associated with ISO containers ultimately add to the cost of the cargo.

While addressing the basic desirability of using general purpose transport vehicles to move bulk cargo, such as liquid, the prior art has failed to provide a single bulk transport system, which is inexpensive to manufacture and is durable enough to be cleaned and reused. A solution must also be robust enough to prevent leakages and not put undue stress on dry box shipping container walls and doors. Moreover, a bulk cargo transport system is also needed in the shipping industry that can pay for itself in three to four shipments and can be amortized over about three to six months as opposed to, e.g., 20 years.

### BRIEF SUMMARY OF THE DISCLOSURE

The present disclosure is directed in general to a bulk cargo transport tank or container. The components of the container are simple to manufacture, install and use.

In general, the bulk cargo transport container may be formed of a rigid material in a variety of shapes; e.g., cylindrical, semi-cylindrical or arcuate, rectangular or otherwise as required by the industry. The container may also be constructed using a single layer or co-extruded layers of material and is suitable for a wide variety of uses including food, chemical and industrial liquid transport. The container meets and exceeds FDA/EC food grade certifications and is Kosher certified.

The stability of the bulk liquid transport container may be enhanced by varying thicknesses of the rigid material and/or by molding a convex upper surface and/or reinforcing members on or into the container to increase strength and to reduce surging of liquid cargo, for instance, when the container is being transported.

The container may be filled under pressure by venting air from a vent located on a top surface of the container. A bottom surface of the container may be cylindrical or square in order to allow for maximum payload. The container may be manufactured with a slight incline towards a discharge end to allow complete discharge of the product. Vent, fill and discharge connections may be located at a rear area, such as a rear door area of an outer dry box container, for easy access and worker safety. The container may further include a manlid clean out port for accessing and cleaning an interior of the container after a cargo shipment.

More particularly, in one aspect of the disclosure, a transport tank system includes a vacuum-formed thermoplastic tank defining an aperture therethrough and having a discharge end and an opposing end, the discharge and opposing ends disposed opposite each other to define a first major axis of the vacuum-formed thermoplastic tank, a first minor axis defined between the discharge and opposing ends substantially perpendicular to the first major axis, the vacuum-formed thermoplastic tank being rigidly configured for holding a consumable cargo received through the aperture; and a transport container having a second major axis and a second minor axis, the vacuum-formed thermoplastic tank being disposed in the transport container, the second major and minor axes being respectively complementary to the first major and minor axes of the vacuum-formed thermoplastic tank, the vacuum-formed tank being further configured for discharge of the consumable cargo.

In this aspect the vacuum-formed thermoplastic tank may be cylindrical in shape.

Also in this aspect the vacuum-formed thermoplastic tank may include at least one arcuate surface.

Further in this aspect the vacuum-formed thermoplastic tank may include a material resistant to passage of oxygen.

Also in this aspect the material may include an ethylene vinyl alcohol copolymer resin. Further the material may be disposed on an internal surface of the vacuum-formed thermoplastic tank, the internal surface being in contact with the consumable cargo.

Further in this aspect the first major axis is longer than the first minor axis of the vacuum-formed thermoplastic tank.

Also in this aspect the opposing end may be disposed above the discharge end to define an incline, the incline being configured to empty the consumable cargo from the vacuum-formed thermoplastic tank.

Further in this aspect the aperture may be a fill connection device.

Also in this aspect the transport container may be a dry box shipping container, the vacuum-formed thermoplastic tank being configured to convert the dry box shipping container into a bulk liquid shipping container.

Further in this aspect the transport container may include a plurality of interior surfaces defining an interior space therein, the vacuum-formed thermoplastic tank being configured to mate against the interior surfaces to occupy the interior space such that the vacuum-formed thermoplastic tank is immobilized in the transport container.

Also in this aspect a vent may be attached to the vacuum-formed thermoplastic tank, the vent being in communication with an internal surface of the vacuum-formed thermoplastic tank and being configured to vent air from the vacuum-formed thermoplastic tank for filling the vacuum-formed thermoplastic tank.

Also in this aspect an inflatable device may be disposed on the internal surface, the inflatable device being configured to further vent the air from the vacuum-formed thermoplastic tank. The inflatable device may be made of a polyethylene material and is further configured for deflation after the air has been vented from the vacuum-formed thermoplastic tank.

Further in this aspect a discharge connection may be attached to the vacuum-formed thermoplastic tank, the discharge connection being in communication with an internal surface of the vacuum-formed thermoplastic tank, the discharge connection being configured to empty the consumable cargo from the vacuum-formed thermoplastic tank.

Also in this aspect a port may be attached to the vacuum-formed thermoplastic tank, the port being in communication with an internal surface of the vacuum-formed thermoplastic tank for cleaning the vacuum-formed thermoplastic tank.

Further in this aspect a pallet assembly may be formed integrally with the vacuum-formed thermoplastic tank.

Also in this aspect a barrier wrapper may be disposed about the thermoplastic tank.

In another aspect of the disclosure, a method of forming a transport tank system includes providing a thermoplastic material; heating the thermoplastic material until the thermoplastic material is malleable; placing the heated thermoplastic material into a tank mold; vacuum forming the heated thermoplastic material into a shape complementary to the tank mold; and cooling the shape into vacuum-formed thermoplastic tank for consumable products.

Also in this aspect the thermoplastic material may be a sheet of thermoplastic material or may be a plurality of thermoplastic pellets, or a combination thereof.

Further in this aspect the vacuum-formed thermoplastic tank may include a material resistant to passage of oxygen. The material may include an ethylene vinyl alcohol copolymer resin.

Also in this aspect the tank mold may include a plurality of depressions defined therein, the depressions forming a plurality of reinforcing members in the vacuum-formed thermoplastic tank.

Further in this aspect the tank mold may include a plurality of depressions defined therein, the depressions forming a plurality of steps or handholds in the vacuum-formed thermoplastic tank.

Also in this aspect the tank mold may include a plurality of depressions defined therein, the depressions forming a pallet assembly integral to the vacuum-formed thermoplastic tank, the pallet assembly having a plurality of openings therein for receipt of respective tines of a forklift for moving the vacuum-formed thermoplastic tank.

Further in this aspect the tank mold may be configured to form an incline to facilitate unloading the consumable product.

Also in this aspect the method may include attaching one of a vent, a connection or a hatch to the vacuum-formed thermoplastic tank.

Also in this aspect the method may include a heating device for maintaining a predetermined temperature of the consumable product.

Also in this aspect the method may include inserting a bladder in the vacuum-formed thermoplastic tank, the bladder being configured for inflation to vent air from the vacuum-formed thermoplastic tank during filling of the consumable products.

Also in this aspect the method may include injecting air into the tank mold while vacuum forming the heated thermoplastic material.

Also in this aspect the method may include inserting a thermoplastic sheet into the mold to reinforce a section of the vacuum-formed thermoplastic tank.

In a further aspect of the disclosure, a transport tank system may include an arcuate-shaped thermoplastic tank defining an aperture therethrough and having a discharge end and an opposing end, the discharge and opposing ends disposed opposite each other to define a first major axis of the thermoplastic tank, a first minor axis defined between the discharge and opposing ends substantially perpendicular to the first major axis, the thermoplastic tank being rigidly configured for holding a consumable cargo received through the aperture and including a material resistant to passage of oxygen to preserve the consumable cargo.

Also in this aspect the thermoplastic tank may be a vacuum-formed thermoplastic tank.

Further in this aspect the thermoplastic tank may be a rotomolded thermoplastic tank.

Also in this aspect the material may include an ethylene vinyl alcohol copolymer resin.

Further in this aspect the thermoplastic tank may include a plurality of reinforcing members configured to increase a rigidity of the thermoplastic tank, the thermoplastic tank being configured for stand-alone storage of the consumable cargo or for shipping the consumable cargo.

Also in this aspect the thermoplastic tank may include a component selected from the group consisting of an air vent, a hatch, a handhold, a filling-discharge connection and a heating device.

This aspect may include a metal transport container, the thermoplastic tank being disposed in the transport container.

In yet another aspect of the disclosure, a method of utilizing a transport tank system includes providing at least two polymeric tanks; stacking one of the polymeric tanks on the other polymeric tank; and filling each of the polymeric tanks with respective bulk consumable cargo.

The method may also include vacuum-forming the polymeric tanks.

The method may also include forming a respective stacking element and an opposing depression on each of the polymeric tanks, the respective stacking elements and depressions being configured to mate with each other to stack one of the polymeric tanks on the other polymeric tank.

The method may also include storing the bulk consumable cargo in the polymeric tanks.

The method may also include placing the polymeric tanks in a shipping container.

Other advantages of various embodiments of the disclosure will be apparent from the following description and the attached drawings, or can be learned through practice of the disclosure.

### BRIEF DESCRIPTION OF THE DRAWINGS

A full and enabling disclosure, including the best mode thereof to one skilled in the art, is set forth more particularly in the remainder of the specification, including reference to the accompanying figures, in which:

FIG. 1 is a perspective view of a transport system particularly showing a container in a dry box (in phantom) according to an aspect of the disclosure;

FIG. 2 is a partially cutaway, perspective view of a container according to another aspect of the disclosure particularly showing various materials that may be used to manufacture the container;

FIG. 3 is a front, elevational view of a container system according to a further aspect of the disclosure;

FIG. 4 is a partially cutaway, side elevational view of the container system as in FIG. 3;

FIG. 5 is a perspective view of a container according to an additional aspect of the disclosure;

FIG. 6 is a schematic view of an exemplary manufacturing process line for a container according to yet another aspect of the disclosure; and

FIG. 7 is partially cutaway, perspective view of a conventional shipping system.

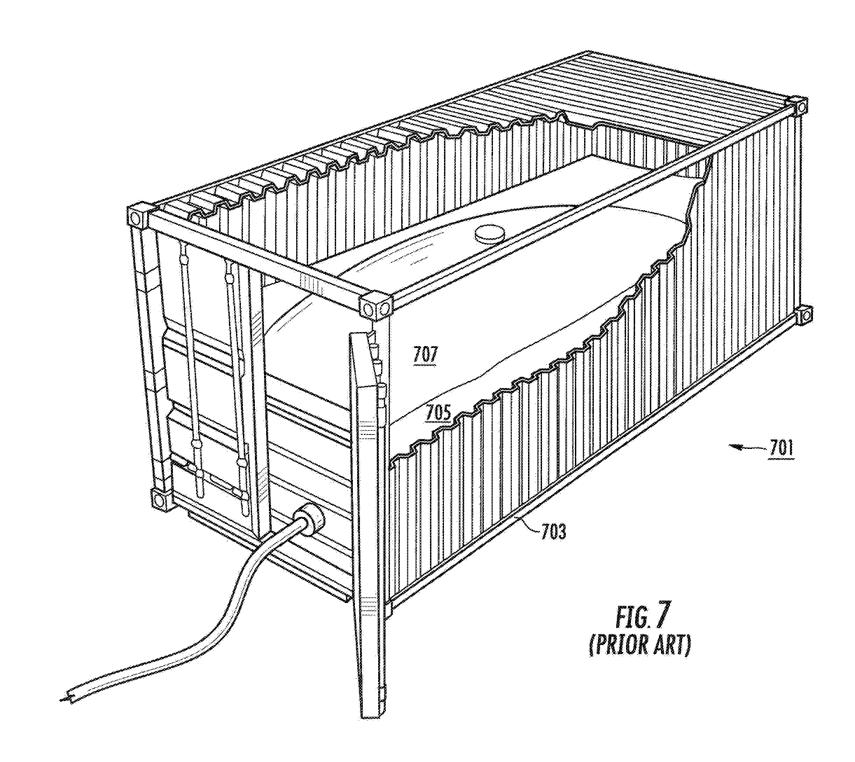

### DETAILED DESCRIPTION OF THE DISCLOSURE

Detailed reference will now be made to the drawings in which examples of the present disclosure are shown. The detailed description uses numerical and letter designations to refer to features of the drawings. Like or similar designations of the drawings and description have been used to refer to like or similar parts of the disclosure.

The drawings and detailed description provide a full and written description of examples of the disclosure, and of the manner and process of making and using these examples, so as to enable one skilled in the pertinent art to make and use them, as well as the best mode of carrying out the disclosure. The examples set forth in the drawings and detailed description are provided by way of explanation only and are not meant as limitations of the disclosure. The present disclosure thus includes any modifications and variations of the following examples as come within the scope of the appended claims and their equivalents.

The figures that are about to be described in detail generally show bulk cargo shipping systems, which generally include a molded, thermo-formed or vacuum-formed container (also referred to herein as a tank or “bottle”). The bulk cargo shipping systems may also include external dry boxes in which the container may fit with minimal clearance to maximize shipping space and to immobilize the container during shipment. These and other advantages and benefits will be better understood from the following description and exemplary methods of operation.

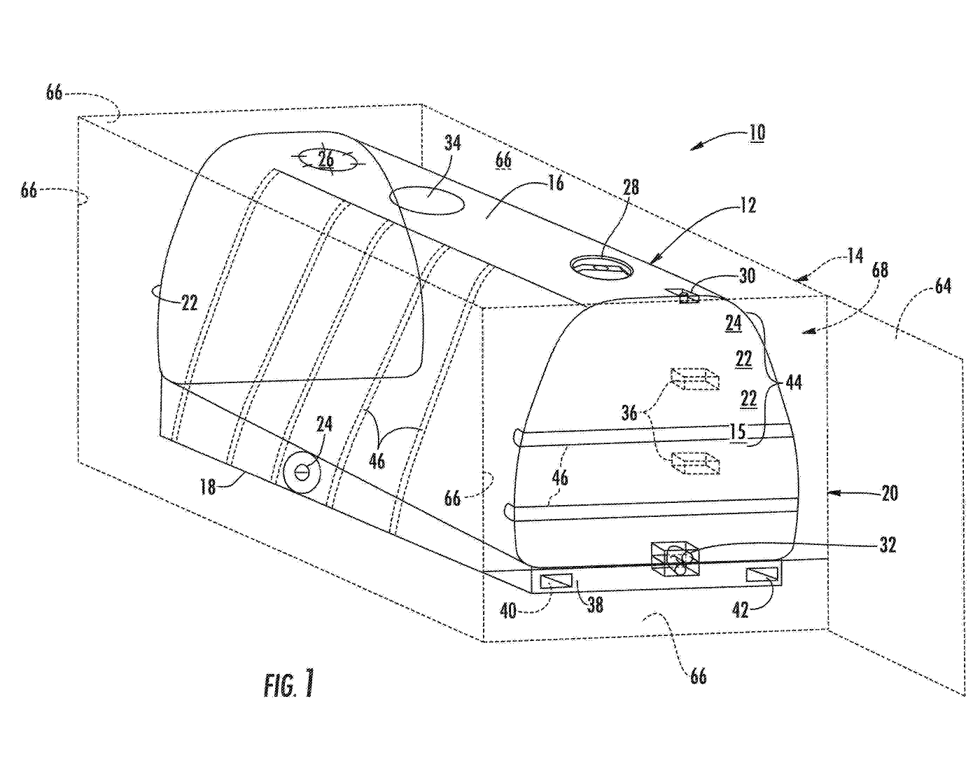

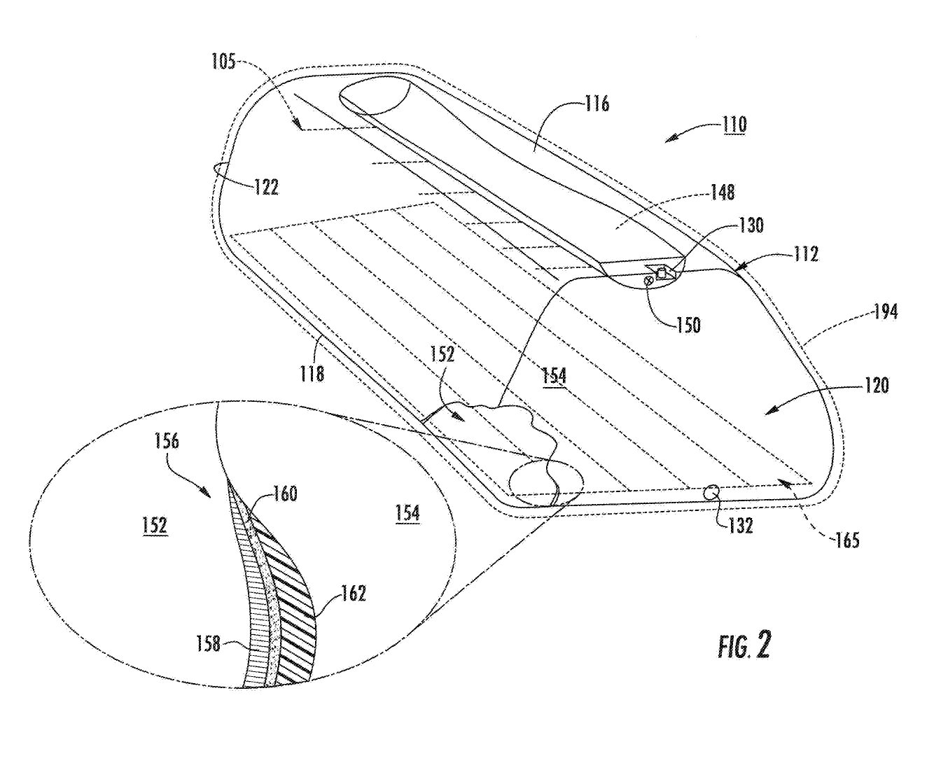

With reference now to FIG. 1, according to an aspect of the present disclosure, a transport container system is designated in general by the element number 10 and may include a container 12 that may be used for transporting or storing liquid, powder or other bulk product or cargo (see, e.g., liquid cargo 105, FIG. 2). The container 12 itself may be inserted and transported in a conventional stainless steel trailer or dry box 14 (depicted in phantom for clarity). As shown, the container 12 includes an upper surface or layer 16, which may be convex or arcuate, and may further include an opposing bottom surface 18 that may be rectangular or square. These and other shapes and arrangements can serve to maximize cargo payload and to increase structural integrity as discussed in greater detail below.

As further shown in FIG. 1, a discharge end 20 and an opposing end 22 define an incline 24 depicted by angle θ, which slants or slopes upward from the discharge end 20 to the opposing end 22 to facilitate gravitational product discharge. In this example, the angle θ of the incline 24 is about 50 degrees as measured from the discharge end 20 to the opposing end 22 relative to horizontal. The skilled artisan will recognize that the angle θ may be more or less than 50 degrees as required. For instance, an increased angle θ may facilitate more rapid product discharge. Additionally, or in the alternative, the container 12 may be equipped with pressure discharge capability of about 0.25 BAR (3.675 PSI) to further facilitate discharge of thick, viscous products by forcing the product out the discharge valve. For example, a discharge connection 32, or a separate valve system, may include this pressure discharge capability. The skilled artisan will understand, of course, that the discharge connection 32 may be capable of pressure discharge more or less than 0.25 BAR as required.

FIG. 1 further shows that the container 12 may include a hatch or manlid 26, which can be used for personnel to access an interior of the container 12. For instance, a sufficiently large hatch 26 may be desirable to inspect the interior or to install various devices, e.g., thermometers, viscosity sensors, etc. (not shown) for cargo monitoring purposes. By way of example, a suitable manlid that may be used as the hatch 26 is disclosed by Podd in U.S. patent application Ser. No. 11/357,521, filed Feb. 17, 2006, which is incorporated by reference thereto.

Also shown in FIG. 1, a fill connection 28 is provided for attaching a hose or line for filling the container 12 with liquid or powered cargo. A vent connection 30 is located at or near the upper surface 16 at or near the discharge end 20 to permit trapped air in the container 12 to escape and to permit the container 12 to be filled as fully as possible. Also as shown in this example, the discharge connection 32 is located in or near the bottom surface 18 of the discharge end 20 to leverage the incline 24 to facilitate complete product discharge.

FIG. 1 also shows a manlid clean out port 34. The manlid clean out port 34 may differ from the hatch 26 in that the manlid clean out port 34 may be larger in circumference than the hatch 26 and/or the manlid clean out port 34 may be configured to require at least two people for operation to ensure personnel safety. Likewise, one or more steps or handholds 36 may be formed in or attached to the container 12 for easy access by and safety of workers. In general, therefore, vent, fill and discharge connections may be located at a readily accessible rear area such as in this example for worker safety. However, it will be understood that the exemplary arrangement shown in FIG. 1 can be adjusted to meet various government regulations and customer requirements.

Also shown in FIG. 1, the container 12 includes a pallet assembly 38, which may be formed integrally with the container 12. Additionally, or in the alternative, the pallet assembly 38 may be attached to the container 12 by adhesives, latches, nuts, screws, bolts and the like. As shown in this example, the pallet assembly 38 may have one or more openings or apertures 40, 42 to receive tines of a forklift (not shown) for moving the container 12. Accordingly, the container 12 does not require a conventional pallet and straps.

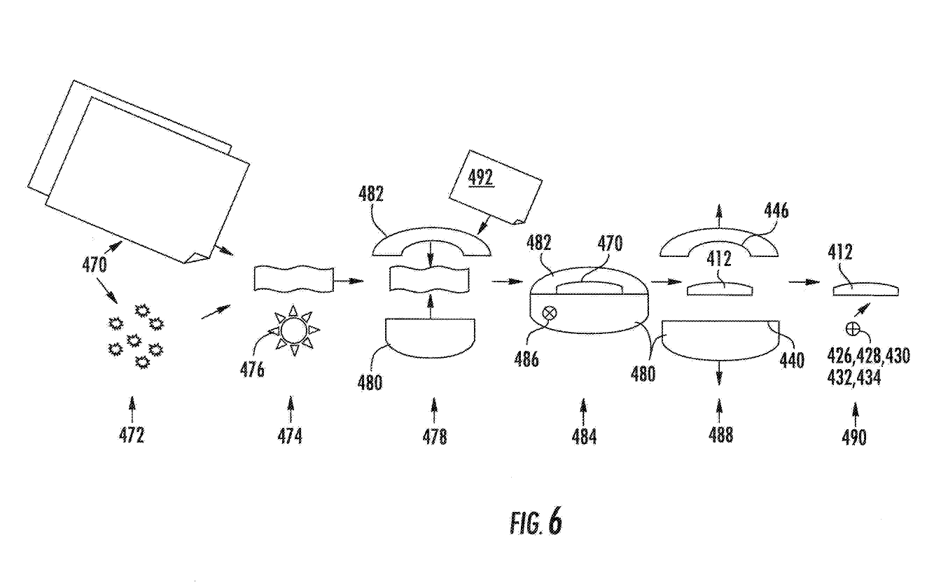

Also in the example of FIG. 1, a plurality of cargo level gauges or markers 44 may be molded onto or into, or painted, or otherwise attached to the container 12 to assist stevedores and loadmasters with judging cargo quantities. In this regard, an opaque or substantially clear thermoplastic may be utilized to manufacture the container 12, which will readily show the loaded cargo relative to the markers 44. On the other hand, a black or other dark color may be desired for the container 12 to shield the cargo from harsh light. Thus, only a relatively small level gauge 44 such as a polycarbonate sight glass may be used to indicate a liquid level. These and other exemplary manufacturing processes for manufacturing the container 12 are discussed in detail below with respect to FIG. 6.

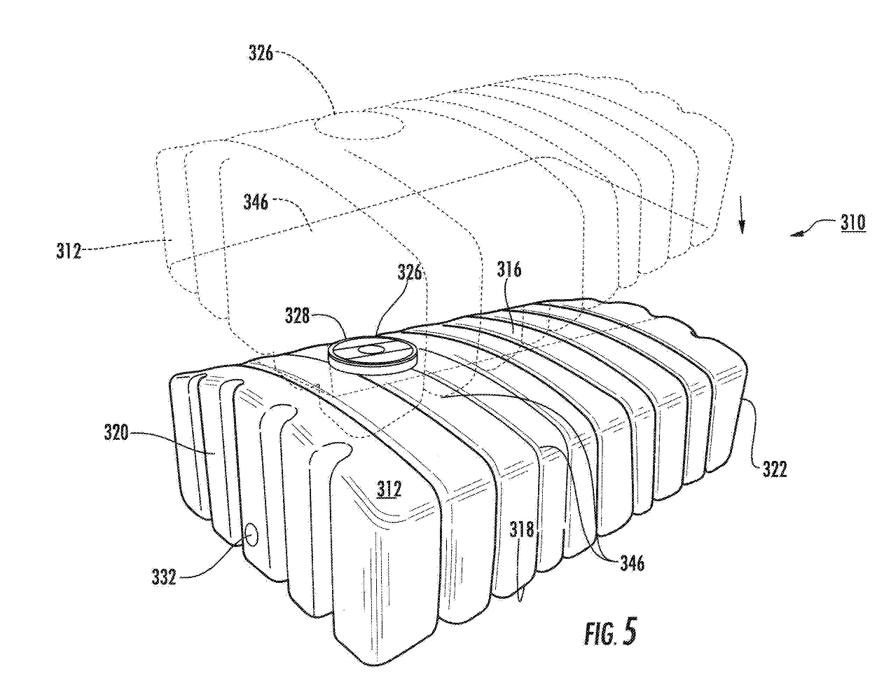

The container 12 may also include a plurality of reinforcing members 46 as shown in FIG. 1 to increase rigidity and durability of the container 12. According to this example, the reinforcing members 46 are spaced a specific distance apart from each other and may run horizontally or vertically, but those skilled in the art will understand and appreciate that the reinforcing members 46 may be spaced farther apart or closer together and may themselves have different widths and shapes other than as shown in the example of FIG. 1. Also, a thickness or thicknesses of the container 12 may be increased or decreased as discussed below with respect to FIG. 2; thus, the number of reinforcing members 46 may be adjusted accordingly. Also as discussed with respect to FIG. 5, ridges, dimples or other reinforcing members 346 may be utilized in addition to or in place of the reinforcing members 46. Thus, the thickness(es) of the container 12, the reinforcing members 46 and/or the ridges 346 can serve to increase rigidity and durability of the container 12 and endow it with stand-alone capability for consumable cargo storage or for shipping the consumable cargo.

With continued reference to FIG. 1, the container 12 is shown inserted in the dry box 14, briefly introduced above, which may convert the dry box 14 into an economical bulk liquid shipping container. As shown, the dry box 14 includes one or more cargo doors 64, which open into a plurality of interior surfaces 66, such as walls, a floor and a ceiling. The interior surfaces 66 define an interior space 68 in which the container 12 sits securely. More specifically, the exterior surfaces of the container 12 may mate against the interior surfaces 66 to immobilize the container 12 during shipment and also to utilize maximum cargo space. As noted above, the vents, fill and discharge connections, and hatches of the container 12 may be located near the cargo doors 64 for worker safety and convenience.

Turning now to FIG. 2, an alternative tank system 110 is shown. Many components and devices of this exemplary system are the same or similar to those of the previous examples; therefore, while some components and aspects are discussed below, reference is made to the foregoing embodiments for a full and enabling description of like or similar components not explicitly discussed.

In the example of FIG. 2, an inflatable device 148, such as a tube or bladder made from polyethylene (PE) for example, is disposed on an internal surface 152 of a tank 112. The inflatable device 148 may include, or is in communication with, an inflation/deflation device 150, which is used to inflate the inflatable device 148. Accordingly, a maximum volume of the tank 112 may be filled with the cargo to increase efficiency and reduce shipping costs. Moreover, the inflatable device 148 may serve as a baffle to prevent the liquid cargo 105 from “sloshing” in the tank 112, which can be harmful during shipping if tanks begin sloshing and create a harmonic rolling effect that may adversely affect the transport ship, train or the like. After the tank 112 is emptied, the device 148 can be deflated using the deflation device 150.

An inset of FIG. 2 most clearly shows an enlarged cutaway section of the tank 112. As shown, at least a portion of an exterior surface 154 of the tank 112 is made of a durable and weather-resistant material such as PE (e.g., high-density polyethylene (HDPE) or low-density polyethylene (LDPE)) or polypropylene, polyvinyl chloride (PVC), hardened rubber, fiberglass, nylon, polyoxymethylene (i.e., acetal plastic (POM)), polyetheretherketone (PEEK), polyethylene terephthalate (PET), or any natural or synthetic materials such as thermoplastics, or their combinations, which are suitable for a punishing shipping environment. In one aspect, the exterior surface 154 may have a thickness of about ¼ of an inch to about 1 inch, preferably at least about ½ of an inch or less. Other thicknesses can be provided to meet specific requirements, and as noted above, thicknesses can be varied throughout the tank 112; for instance, the surface 154 may be relatively thicker near a bottom 118 and relatively thinner near a top 116 of the tank 112.

More specifically, a relatively large tank for storing and shipping liquids can be made from a polymeric material such as polyethylene because a PE tank can be efficiently manufactured, such as by blow molding or vacuum-forming, and the polymeric tank is lightweight. Also, a co-extruded layer of ethylene vinyl alcohol copolymer (EVOH) resin or similar layer of material having a high barrier to oxygen may be used in the container 112 to prevent adversely affecting the taste of the product contained within the container 112. EVOH, for instance, is known for its gas barrier properties and its resistance to solvents, chemicals and the like.

In the example shown in FIG. 2, a permeation barrier 156 may have multiple layers including, for instance, an oxygen barrier such as EVOH, depicted here as layer 158, a layer of adhesive 160, and a layer of polymeric material 162 such as PE. As shown, the permeation barrier 156 is disposed on the internal surface 152 of the tank 112 to be in contact with a consumable cargo 105 to prevent adversely affecting the taste of wine, juices, dairy or other consumable liquids or foods, which might occur due to oxygen permeation of PE without a layer 158.

As shown in FIG. 2, the layer 158 is between about 0.001 millimeters to about 5 millimeters to meet more or less stringent permeation requirements. The exemplary EVOH resin is available, for instance, under the brand name EVAL from EVAL Europe N.V. in Zwijndrecht, Belgium, although comparable sources may be substituted. Again, although EVOH is used as the layer 158, any resin or material with suitable gas barrier properties can be substituted for the layer 158. The entire bulk liquid transport system may also be sealed inside a foil laminate or other type of barrier wrapper 194 to protect against exterior contamination. Such a wrapper is available from Powertex of Rouses Point, N.Y. under the brand name Powerfoil.

The layer 158 shown in FIG. 2 can be applied to the internal surface 152 of the tank 112 by a spraying process, a lamination process, a dip/bath process, a (co-)extrusion process, a molding process, a vacuum-forming process, an adhesive process and the like. For instance, the layer 158 may be co-extruded with the PE material 162 to protect the EVOH from wear. The layer of adhesive 160 may also be co-extruded and disposed between the layers 158, 162 to adhere the PE and EVOH together since PE and EVOH are not chemically bonded. An adhesive suitable as the adhesive 160 is available under the brand name ADMER GT6E resin from Mitsui Chemicals Europe GmbH of Duesseldorf, Germany. However, it is to be noted that any comparable adhesive suitable for adhering the layers 158, 162 together can be used according to the present invention. It is again to be further noted that although the layers 158, 162 are co-extruded, other processes such as laminations, baths, sprays, overmolding, and the like can be used to form the multi-layer permeation barrier 156.

As further shown in FIG. 2, a heating pad or a plurality of heating strips 165 may be attached to or embedded in or near a bottom surface 118 of the tank 112. The pad 165 may include a plurality of heated water tubes or electrical strips, either of which is configured to supply a sufficiently high temperature to maintain viscosity of, for instance, a syrup cargo without affecting the material makeup of the tank 112 or heat the cargo prior to discharge.

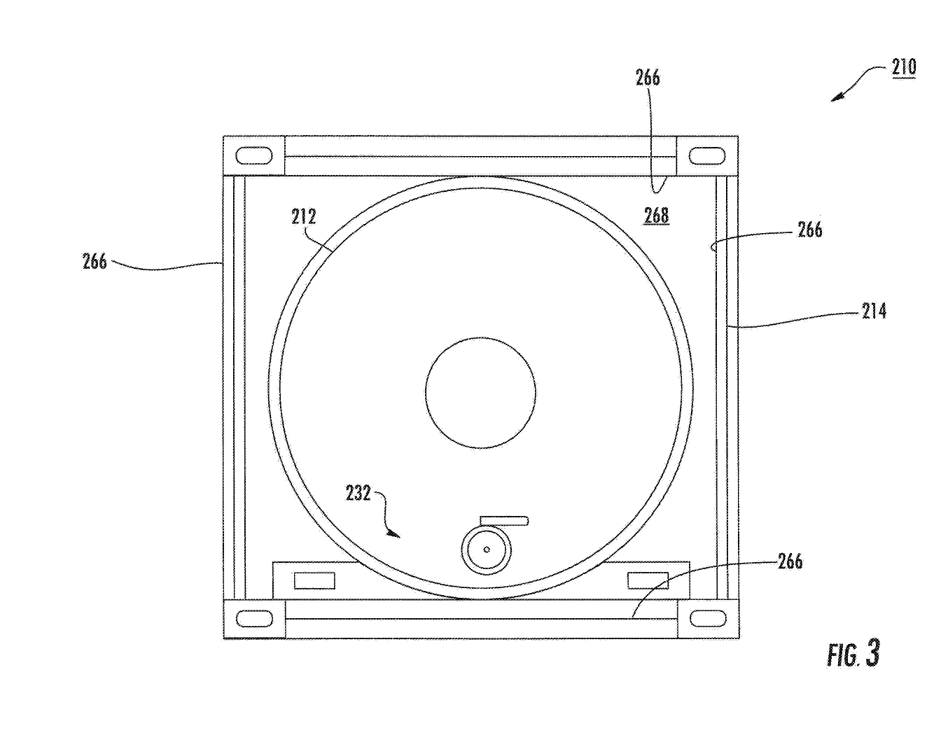

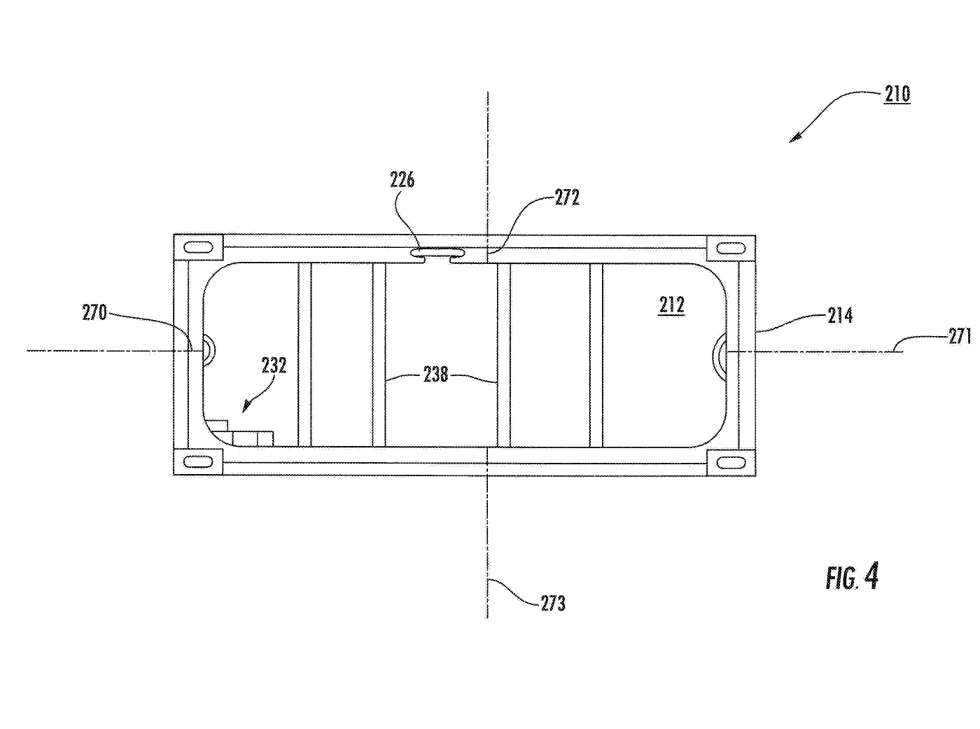

With reference now to FIGS. 3 and 4, a further exemplary embodiment of a tank transport system 210 is provided. Once again, many components of this embodiment are the same or similar to elements or components of the previous examples; therefore, some components are discussed below and reference is made to the foregoing embodiments for a full and enabling description of like or similar components not otherwise discussed.

As shown in FIGS. 3 and 4, the tank transport system 210 may include a polymeric tank 212 for transporting and/or storing bulk cargo, such as liquids and powders. Although the tank 212 is manufactured of a rigid, durable polymeric material and is capable of stand-alone use, the tank 212 may also be used with and transported in a shipping container 214.

As shown most clearly in FIG. 4, the tank 212 may be a vacuum-formed thermoplastic tank, which is substantially cylindrical in shape in this example. As shown, the tank 212 has a major axis 270 and a minor axis 272; i.e., the exemplary tank 212 is longer horizontally than vertically. As further shown, the shipping container 214 has a second, complementary major axis 271, and a second, complementary minor axis 273, which are respectively co-axial with the major and minor axes 270, 272 of the tank 212. Although space appears between the tank 212 and the shipping container 214 in FIG. 4, it will be appreciated that the space is exaggerated merely to show the axes 270, 271, 272, 273 most clearly.

Turning now to FIG. 5, an alternative embodiment of a tank transport system 310 is shown, which includes a tank 312. As above, many components of this embodiment are the same or similar to elements or components of the previous examples; therefore, some components are discussed below and reference is made to the foregoing embodiments for a full and enabling description of like or similar components not otherwise discussed.

As shown in FIG. 5, the tank 312 is manufactured of a rigid, durable polymeric material such as PE. The walls and surfaces 316, 318, 320 and 322 are at least about ½ inch in thickness in this example but can be thicker or thinner in various areas such as corner pressure points in order to use the tank 312 standing alone as shown for cargo storage or shipping. As discussed relative to the foregoing embodiments, however, the tank 312 may be used with and transported in a dry box, such as the shipping container 214 shown in FIG. 4.

As further shown in FIG. 5 and briefly introduced above with respect to FIG. 1, the tank 312 may have ridges, dimples or other reinforcing members 346. The members 346 can be molded or attached in a variety of shapes and manners to increase rigidity and durability of the container 312 as discussed above. Moreover, the members 346 can be formed to enable a plurality of tanks 312 to be stacked one on top of the other to conserve and maximize limited cargo space. Accordingly, for instance, one tank 312 may carry wine while another tank 312 (shown in phantom for clarity) may carry a powder cargo in the same shipping container.

Additionally, in a further aspect of the disclosure, at least two empty tanks 312 may fit in a forty foot container for empty repositioning. This is of course a function of the sizes of the tanks 312 and the type of container that may be used to reposition the tanks 312. For example, an insulated, refrigerated container (i.e., a reefer), which although in some ways similar to the dry box 14 discussed above, may require relatively small tanks 312 since an internal width of the reefer may only be about 88 inches, versus 92 inches in the standard dry box 14. Accordingly, the tanks 312 may be sized to fit inside a 40 foot reefer and/or may be placed sideways in the reefer for empty repositioning. Alternatively, if the tanks 312 are each about 92 inches wide, the tanks 312 may be turned on their sides to allow two of them to fit into an 88 inch wide reefer.

The disclosure may be better understood with reference to exemplary manufacturing processes.

As broadly shown in FIG. 6, a tank 412 may be manufactured by rotational molding (rotomolding), injection molding, blow molding, vacuuming forming or the like. By way of example, the rotomolding process may begin with a quality cast or fabricated mold, which is placed in a rotomolding machine. Pre-measured plastic resin such as HDPE is loaded into the mold and moved into an oven (see, e.g., heater 476) where the HDPE is slowly rotated on both vertical and horizontal axes. The melting HDPE resin sticks to the hot mold and evenly coats every surface of the mold unless otherwise required, e.g., to form various thicknesses. Lastly, the rotomolded shell is moved to a cooling area where it is cooled and released from the mold and sent to the staging or finishing area.

Rotational speed, heating and cooling times are all controlled throughout the foregoing process and each can be adjusted to modify characteristics of the tank 412. As noted above, the tank 412 can have differing thicknesses in particular sections, for instance, about ¾ of an inch of HDPE at a top edge and about ½ inch of HDPE at a bottom surface.

As FIG. 6 most clearly shows, at stage 472 a plurality of thermoplastic sheets 470 or thermoplastic pellets 472 are provided. At stage 474, the thermoplastic 470, 472 is either heated to a desired temperature or melted by a heater or heating source 476 to form a malleable sheet or a melted mixture. At stage 478, the thermoplastic 470, 472 is placed or poured into a mold. In this example, the mold is a vacuum mold having a bottom 480 and a top 482. As indicated by the arrows in stage 478, the bottom 480 and the top 482 are pressed together with the heated thermoplastic 470, 472 therein. At stage 484, the heated thermoplastic is vacuum formed into a shape complementary to the bottom 480 and the top 482 of the tank mold. More specifically, a vacuum-blower device 486 vacuums the thermoplastic 470, 472 from both the bottom 480 and the top 482 while simultaneously blowing air into the mold to form the hollow interior of the tank 412.

At stage 488, the vacuum-formed tank 412 is removed from the mold and cooled. The skilled artisan will appreciate that the bottom 480 and the top 482 of the mold may be formed with depressions, projections and the like 440, 446 to create respective ridges, dimples, apertures, reinforcing members and the like in the tank 412 as discussed in detail with respect to FIG. 5 above.

At stage 490 in FIG. 6, various hatches, clean-out ports, filling and discharge connections, handholds and the like, generally indicated by reference numerals 426, 428, 430, 432, 434 may be attached to or inserted in the apertures of the formed tank 412.

With more particular reference to one aspect shown in FIG. 6, the thermoplastic 470 may be at least two sheets of thermoplastic material that are each about ½ inch in thickness at stage 474. After heating the two sheets 470 at 474 and inserting the malleable sheets into the mold at stage 478, the sheets 470 are respectively vacuumed from the bottom 480 and a top 482 while air is blown between them to vacuum form the sheets into the tank 412 in approximately five (5) minutes. In this example, after stretching and filling the mold, the sheets 470 and thus the formed tank 412 is about ⅛ of an inch in thickness. However, as discussed in detail above, the initial sheets 470 may be thicker or thinner than ½ inch as desired to achieve a different finished tank thickness. Moreover, the mold and/or the thermoplastic commodity may be varied in thickness to achieve different thicknesses at different points in the finished tank 412, such as greater thicknesses at corner points of the tank 412 to increase durability. Further, the tank 412 may be formed with sufficient thickness and thus strength such that no bulkhead is required. This is accomplished by inserting a solid plastic sheet 492 into the mold before blowing to reinforce a door end or other desired section of the tank 412. Finally, one or more of the sheets 470 or a portion of the pellets 470 may include material resistant to passage of oxygen, such as EVOH as discussed above.

While preferred embodiments have been shown and described, those skilled in the art will recognize that other changes and modifications may be made to the foregoing examples without departing from the scope and spirit of the disclosure. For instance, various durable materials can be used for the tank as described herein and a variety of shapes and geometries can be achieved using different molds. It is intended to claim all such changes and modifications as fall within the scope of the appended claims and their equivalents.

That which is claimed is:

1. A transport tank system, comprising:
a vacuum-formed thermoplastic tank defining an aperture therethrough and having a discharge end and an opposing end, the discharge and opposing ends disposed opposite each other to define a first major axis of the vacuum-formed thermoplastic tank, a first minor axis defined between the discharge and opposing ends substantially perpendicular to the first major axis, the vacuum-formed thermoplastic tank being rigidly configured for holding a consumable cargo received through the aperture; and
a transport container having a second major axis and a second minor axis, the vacuum-formed thermoplastic tank being disposed in the transport container, the second major and minor axes being respectively complementary to the first major and minor axes of the vacuum-formed thermoplastic tank, the vacuum-formed tank being further configured for discharge of the consumable cargo.

2. The transport tank system as in claim 1, wherein the vacuum-formed thermoplastic tank is cylindrical in shape.

3. The transport tank system as in claim 1, wherein the vacuum-formed thermoplastic tank includes at least one arcuate surface.

4. The transport tank system as in claim 1, wherein the vacuum-formed thermoplastic tank includes a material resistant to passage of oxygen.

5. The transport tank system as in claim 4, wherein the material includes an ethylene vinyl alcohol copolymer resin.

6. The transport tank system as in claim 1, wherein the material is disposed on an internal surface of the vacuum-formed thermoplastic tank, the internal surface being in contact with the consumable cargo.

7. The transport tank system as in claim 1, wherein the first major axis is longer than the first minor axis of the vacuum-formed thermoplastic tank.

8. The transport tank system as in claim 1, wherein the opposing end is disposed above the discharge end to define an incline, the incline being configured to empty the consumable cargo from the vacuum-formed thermoplastic tank.

9. The transport tank system as in claim 1, wherein the aperture is a fill connection device.

10. The transport tank system as in claim 1, wherein the transport container is a dry box shipping container, the vacuum-formed thermoplastic tank being configured to convert the dry box shipping container into a bulk liquid shipping container.

11. The transport tank system as in claim 1, wherein the transport container includes a plurality of interior surfaces defining an interior space therein, the vacuum-formed thermoplastic tank being configured to mate against the interior surfaces to occupy the interior space such that the vacuum-formed thermoplastic tank is immobilized in the transport container.

12. The transport tank system as in claim 1, further comprising a vent attached to the vacuum-formed thermoplastic tank, the vent being in communication with an internal surface of the vacuum-formed thermoplastic tank and being configured to vent air from the vacuum-formed thermoplastic tank for filling the vacuum-formed thermoplastic tank.

13. The transport tank system as in claim 1, further comprising an inflatable device disposed on the internal surface, the inflatable device being configured to further vent the air from the vacuum-formed thermoplastic tank.

14. The transport tank system as in claim 1, wherein the inflatable device is made of a polyethylene material and is further configured for deflation after the air has been vented from the vacuum-formed thermoplastic tank.

15. The transport tank system as in claim 1, further comprising a discharge connection attached to the vacuum-formed thermoplastic tank, the discharge connection being in communication with an internal surface of the vacuum-formed thermoplastic tank, the discharge connection being configured to empty the consumable cargo from the vacuum-formed thermoplastic tank.

16. The transport tank system as in claim 1, further comprising a port attached to the vacuum-formed thermoplastic tank, the port being in communication with an internal surface of the vacuum-formed thermoplastic tank for cleaning the vacuum-formed thermoplastic tank.

17. The transport tank system as in claim 1, further comprising a pallet assembly formed integrally with the vacuum-formed thermoplastic tank.

18. A method of forming a transport tank system, the method comprising:
providing a thermoplastic material;
heating the thermoplastic material until the thermoplastic material is malleable;
placing the heated thermoplastic material into a tank mold;
vacuum forming the heated thermoplastic material into a shape complementary to the tank mold; and,
cooling the shape into vacuum-formed thermoplastic tank for consumable products.

19. The method as in claim 18, wherein the thermoplastic material is a sheet of thermoplastic material.

20. The method as in claim 18, wherein the thermoplastic material is a plurality of thermoplastic pellets.

21. The method as in claim 18, wherein the vacuum-formed thermoplastic tank includes a material resistant to passage of oxygen.

22. The method as in claim 21, wherein the material includes an ethylene vinyl alcohol copolymer resin.

23. The method as in claim 18, wherein the tank mold includes a plurality of depressions defined therein, the depressions forming a plurality of reinforcing members in the vacuum-formed thermoplastic tank.

24. The method as in claim 18, wherein the tank mold includes a plurality of depressions defined therein, the depressions forming a plurality of steps or handholds in the vacuum-formed thermoplastic tank.

25. The method as in claim 18, wherein the tank mold includes a plurality of depressions defined therein, the depressions forming a pallet assembly integral to the vacuum-formed thermoplastic tank, the pallet assembly having a plurality of openings therein for receipt of respective tines of a forklift for moving the vacuum-formed thermoplastic tank.

26. The method as in claim 18, wherein the tank mold is configured to form an incline to facilitate unloading the consumable product.

27. The method as in claim 18, further comprising attaching one of a vent, a connection or a hatch to the vacuum-formed thermoplastic tank.

28. The method as in claim 18, further comprising including a heating device for maintaining a predetermined temperature of the consumable product.

29. The method as in claim 18, further comprising inserting a bladder in the vacuum-formed thermoplastic tank, the bladder being configured for inflation to vent air from the vacuum-formed thermoplastic tank during filling of the consumable products.

30. The method as in claim 18, further comprising injecting air into the tank mold while vacuum forming the heated thermoplastic material.

31. The method as in claim 18, further comprising inserting a thermoplastic sheet into the mold to reinforce a section of the vacuum-formed thermoplastic tank.

32. A transport tank system, comprising:
an arcuate-shaped thermoplastic tank defining an aperture therethrough and having a discharge end and an opposing end, the discharge and opposing ends disposed opposite each other to define a first major axis of the thermoplastic tank, a first minor axis defined between the discharge and opposing ends substantially perpendicular to the first major axis, the thermoplastic tank being rigidly configured for holding a consumable cargo received through the aperture and including a material resistant to passage of oxygen to preserve the consumable cargo.

33. The transport tank system as in claim 32, wherein the thermoplastic tank is a vacuum-formed thermoplastic tank.

34. The transport tank system as in claim 32, wherein the thermoplastic tank is a rotomolded thermoplastic tank.

35. The transport tank system as in claim 32, wherein the material includes an ethylene vinyl alcohol copolymer resin.

36. The transport tank system as in claim 32, wherein the thermoplastic tank includes a plurality of reinforcing members configured to increase a rigidity of the thermoplastic tank, the thermoplastic tank being configured for stand-alone storage of the consumable cargo or for shipping the consumable cargo.

37. The transport tank system as in claim 32, further comprising a component selected from the group consisting of an air vent, a hatch, a handhold, a filling-discharge connection and a heating device.

38. The transport tank system as in claim 32, further comprising a metal transport container, the thermoplastic tank being disposed in the transport container.

39. The transport tank system as in claim 32, further comprising a barrier wrapper disposed about the thermoplastic tank.

40. A method of utilizing a transport tank system, the method comprising:
providing at least two polymeric tanks;
stacking one of the polymeric tanks on the other polymeric tank; and
filling each of the polymeric tanks with respective bulk consumable cargo.

41. The method as in claim 40, further comprising vacuum-forming the polymeric tanks.

42. The method as in claim 40, further comprising forming a respective stacking element and an opposing depression on each of the polymeric tanks, the respective stacking elements and depressions being configured to mate with each other to stack one of the polymeric tanks on the other polymeric tank.

43. The method as in claim 40, further comprising storing the bulk consumable cargo in the polymeric tanks.

44. The method as in claim 40, further comprising placing the polymeric tanks in a shipping container.
